(19) United States
(12) Patent Application Publication
(10) Pub. No.: US 2024/0318975 A1
(43) Pub. Date: Sep. 26, 2024

(54) INFORMATION MANAGEMENT SYSTEM

(71) Applicant: TOYOTA JIDOSHA KABUSHIKI KAISHA, Toyota-shi (JP)

(72) Inventor: Kaori YAMADA, Nagakute-shi (JP)

(73) Assignee: TOYOTA JIDOSHA KABUSHIKI KAISHA, Toyota-shi (JP)

(21) Appl. No.: 18/413,438

(22) Filed: Jan. 16, 2024

(30) Foreign Application Priority Data
Mar. 23, 2023 (JP) 2023-046378

(51) Int. Cl. G01C 21/36; B60L 53/68

(52) U.S. Cl. CPC G01C 21/3679; B60L 53/68; G01C 21/362; G01C 21/3697; B60L 2240/62; B60L 2250/16

(57) ABSTRACT

A terminal executes the process including a step of transmitting model information and location information, when the terminal receives a search request, and a step of executing display processing, when it receives charging station information. When the management server receives the model information and the position information, the management server executes a step of extracting, a step of acquiring various temperatures, and a step of calculating the SOC recovery amount and transmitting the charging station information.

### CROSS-REFERENCE TO RELATED APPLICATION

This application claims priority to Japanese Patent Application No. 2023-046378 filed on Mar. 23, 2023, incorporated herein by reference in its entirety.

### BACKGROUND

### 1. Technical Field

The present disclosure relates to an information management system.

### 2. Description of Related Art

There is known technology regarding searching for a charging station in a vicinity of a vehicle equipped with a power storage device that is externally chargeable, where the power storage device can be charged, using an in-vehicle automotive navigation system, a terminal owned by a user, or the like.

For example, Japanese Unexamined Patent Application Publication No. 2020-193903 (JP 2020-193903 A) discloses technology for displaying icons by which the user can recognize charging methods and output power levels of a plurality of chargers on an image showing a map of an automotive navigation system.

### SUMMARY

However, an amount of charge that can be charged per predetermined amount of time at a charging station varies depending not only on model and capacity of the power storage device installed in the vehicle, but also on external temperature environment such as outside temperature and so forth, state of the power storage device, and so forth. Accordingly, even when the charging station is selected based on charging method and magnitude of output electric power, the amount of charge intended by the user may not be able to be charged.

The present disclosure provides an information management system capable of providing information regarding charging stations that are capable of performing charging intended by the user.

An information management system according to an aspect of the present disclosure includes
a plurality of charging facilities, each of the charging facilities being configured to externally charge a power storage device installed in a vehicle,
a server that manages a chargeable amount that is chargeable to the power storage device in a predetermined period, in each of the charging facilities, and
a terminal that includes a display device and that is configured to make a search request to the server for the charging facilities.

Upon receiving the search request, the server causes the display device of the terminal to display information regarding the charging facility in a vicinity of an object point, and the chargeable amount at the charging facility.

According to this arrangement, the terminal displays the chargeable amount in the predetermined period at charging facilities in the vicinity of the object point, so that the user can select a charging station that is capable of charging as intended by the user.

In an embodiment,
when the charging of the power storage device is completed, the charging facility may transmit charging history, along with model information of the vehicle and information regarding the power storage device, to the server.

The server may update the chargeable amount for each model, using the charging history.

According to this arrangement, the charging history is used to update the chargeable amount for each model, and thus highly accurate information regarding charging stations that are capable of charging as intended by the user can be acquired.

In yet another embodiment,
the charging history may include an amount of charge in the predetermined period, history of outside temperature during charging, and history of temperature of the power storage device.

According to this arrangement, an accurate chargeable amount corresponding to temperature environment can be acquired, by using the amount of charge in the predetermined period, the history of the outside temperature during charging, and the temperature history of the power storage device.

In yet another embodiment,
the terminal may set a current position of the vehicle as the object point.

According to this arrangement, a charging station that is capable of charging as intended by the user can be selected in the vicinity of the current position of the vehicle.

In yet another embodiment,
the terminal may set a point that is partway between a current position of the vehicle and a destination of the vehicle, and also that is a point at a distance shorter than a travelable distance of the vehicle, as the object point, and may display the charging facility acquired by the search request on the display device as an option for a waypoint.

According to this arrangement, an appropriate charging facility can be selected as a waypoint when charging is required before reaching the destination.

According to the present disclosure, an information management system can be provided that can provide information regarding charging stations that are capable of charging as intended by the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining an example of the configuration of an information management system;

FIG. 2 is a flowchart showing an example of processing executed between a vehicle, a management server, and a charging station;

FIG. 3 is a diagram showing an example of charging prediction information in tabular format; and

FIG. 4 is a flowchart illustrating an example of processing executed between a management server and a terminal.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

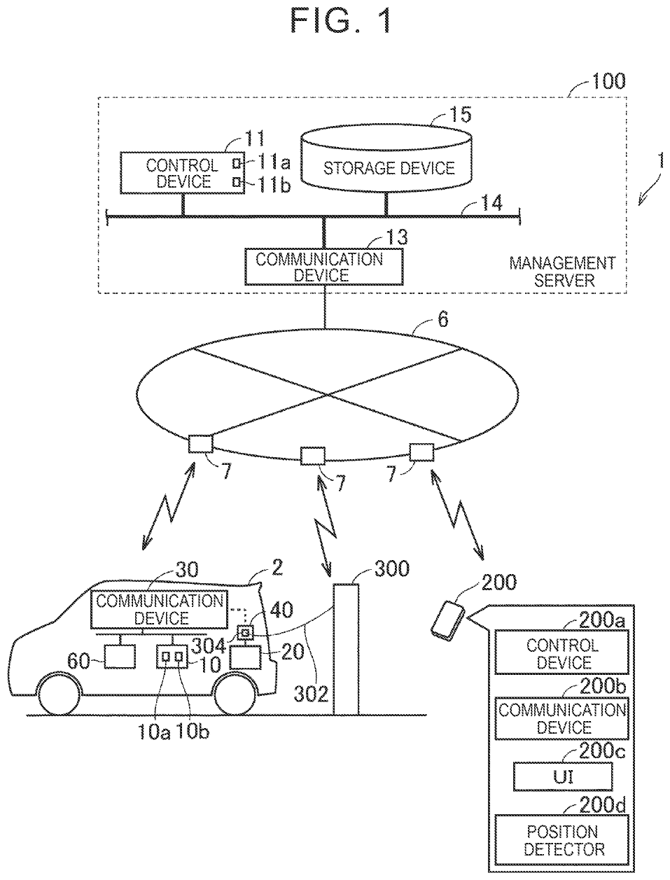

FIG. 1 is a diagram for explaining an example of the configuration of an information management system 1. As shown in FIG. 1, information management system 1 includes vehicle 2, communication network 6, base station 7, management server 100, terminal 200, and charging station 300 in this embodiment.

The vehicle 2 may be, for example, an electrified vehicle equipped with an externally chargeable power storage device. For example, it may be a battery electric vehicle of which the drive source is an electric motor, or a hybrid electric vehicle equipped with an engine and an electric motor, and using either one as a drive source. For convenience of explanation, FIG. 1 shows only one vehicle 2 as a vehicle connected to charging station 300, but the number of vehicles connected to charging station 300 is not particularly limited to one, and a case in which multiple vehicles are connected to the charging station 300 is included.

The information management system 1 acquires or provides predetermined information from at least one of the vehicle 2, the terminal 200, and the charging station 300 configured to communicate with the management server 100, It is configured to manage acquired information and provided information.

The management server 100 includes a control device 11, a communication device 13, a storage device 15, and a communication bus 14 that communicably connects each component.

The control device 11 includes a processor 11a such as a Central Processing Unit (CPU) that executes programs, a memory (Read Only Memory (ROM), Random Access Memory (RAM), etc.) 11b, and the like. Various controls executed by the control device 11 are executed by software processing, that is, the programs stored in the memory 11b are read by the CPU 11a. Various controls by the control device 11 can also be realized by a general-purpose computer (not shown) executing a program stored in a storage medium. Various controls by the control device 11 are not limited to software processing, and may be processed by dedicated hardware (electronic circuits).

Storage device 15 stores predetermined information about charging station 300 configured to be communicable with management server 100. The predetermined information includes, for example, information regarding the position and charging capability of charging station 300, which will be described later, and information for identifying charging station 300 (hereinafter referred to as charging station ID). The charging station ID is unique information set for each charging station. The management server 100 can specify the position of the charging station 300 by the charging station ID.

The communication device 13 implements two-way communication between the control device 11 and the communication network 6. The management server 100 enables mutual communication with the vehicle 2 equipped with the communication device 30 via the base station 7 provided on the communication network 6 using the communication device 13. Furthermore, the management server 100 enables mutual communication with the terminal 200 via the base station 7 provided on the communication network 6 using the communication device 13.

The terminal 200 is, for example, a portable terminal owned by the user of the vehicle 2, such as a smart phone, a tablet terminal, or a wearable device. The terminal 200 includes a control device 200a having a processor such as a CPU and a memory for executing programs, a communication device 200b capable of communicating with the management server 100 via the base station 7, and a user interface (hereinafter referred to as UI) 200c and a position detection device 200d. The UI 200c includes, for example, a display 20 device that displays predetermined information and a touch panel that receives user operations. In the terminal 200, an application and a browser that can connect to the management server 100 and search for charging spots around the terminal 200 are available and stored. The position detection device 200d detects the position of the vehicle 2, for example. The position detection device 200d is, for example, a receiving device that receives signals (radio waves) from Global Positioning System (GPS) satellites, wireless Local Area Network (LAN) base stations, and the like.

charging station 300 is provided, for example, in at least one of a plurality of parking spaces provided in a parking lot, and one charging station 300 is representatively shown in FIG. 1.

A power line (not shown) that is connected to a power network is connected to charging station 300. One end of cable 302 is connected to charging station 300. A connector 304 is connected to the other end of the cable 302. Connector 304 has a structure that can be connected to inlet 40 of vehicle 2. In FIG. 1, connector 304 is shown connected to inlet 40 of vehicle 2.

By connecting connector 304 to inlet 40, electric power can be transferred between charging station 300 and power storage device 20 of vehicle 2. Charging station 300 includes, for example, a control device and a communication device (both not shown), and is configured to enable wireless or wired communication with management server 100 via base station 7 and communication network 6.

Charging station 300 includes a control device having a processor such as a CPU that executes programs and a memory, and a communication device configured to communicate with management server 100 via base station 7. Further, the communication device of charging station 300 may be configured to be capable of power line communication with vehicle 2 using the power line included in cable 302 as a communication line, or may be configured to be capable of wireless communication.

Next, a specific configuration of the vehicle 2 will be described. Vehicle 2 further includes an Electronic Control Unit (ECU) 10, a power storage device 20, a communication device 30 configured by a Data Communication Module (DCM), an inlet 40 and a navigation device 60.

The ECU 10 is a computer having a processor 10a such as a CPU that executes programs, and a memory 10b. The ECU 10 includes various control programs for controlling various actuators mounted on the vehicle 2.

Power storage device 20 is a rechargeable direct-current power supply, and is composed of, for example, a nickel-metal hydride battery, a secondary battery such as a lithium ion battery containing a solid or liquid electrolyte, a capacitor, or the like.

The communication device 30 is configured to be capable of two-way communication (wired or wireless communication) with the management server 100 via the communication network 6 and the base station 7.

The navigation device 60 includes, for example, a position detection device that identifies the position of the vehicle 2 using signals (radio waves) received from GPS satellites, wireless LAN base stations, etc., a database that stores map information and travel history, and a CPU, etc. (none of which are shown). The navigation device 60 specifies a travel route on a map from the current position of the vehicle 2 to the destination, and guides the vehicle 2 traveling along the travel route to the destination. The navigation device 60 displays map information and guidance information on a touch panel display (not shown), specifies a destination input by the user through the user's operation on the touch panel, and displays options of a plurality of travel routes to the specified destination. Further, the navigation device 60 is configured to be able to display charging stations available around the vehicle 2 as options to the user by operating the touch panel by the user.

A user of vehicle 2 configured as described above searches for charging station 300 capable of charging power storage device 20 using navigation device 60, terminal 200, or the like. More specifically, when the searched charging stations are displayed on a display device such as navigation device 60 or terminal 200, for example, the available charging methods and the magnitude of the output power can be displayed in an identifiable manner. Conceivable. However, the amount of charge that can be charged in a predetermined period varies depending not only on the model and the capacity of the power storage device, but also on the external temperature environment such as the outside temperature, the state of the power storage device, and the like. Accordingly, even when the charging station is selected based on charging method and magnitude of output electric power, the amount of charge intended by the user may not be able to be charged.

Therefore, in the present embodiment, when management server 100 receives a request to search for charging station 300 (hereinafter referred to as a search request), management server 100 receives the search request. It is assumed that information about charging facilities in the vicinity of the object point and the chargeable amount at the charging facilities is displayed on the terminal. In the present embodiment, a case where the management server 100 causes terminal 200 to display the information will be described as an example.

Furthermore, in each of the plurality of charging stations, when charging of power storage device 20 is completed, model information of vehicle 2 in which power storage device 20 is mounted, information about power storage device 20, and charging history are transmitted to management server 100. The management server 100 updates the chargeable amount for each model using the charging history.

In this way, the terminal 200 displays the chargeable amount for a predetermined period at charging facilities around the object point, so that the user can select a charging station that allows charging as intended by the user. Furthermore, since the chargeable amount is updated for each model using the charging history, it is possible to obtain highly accurate information on the charging stations where charging intended by the user is possible.

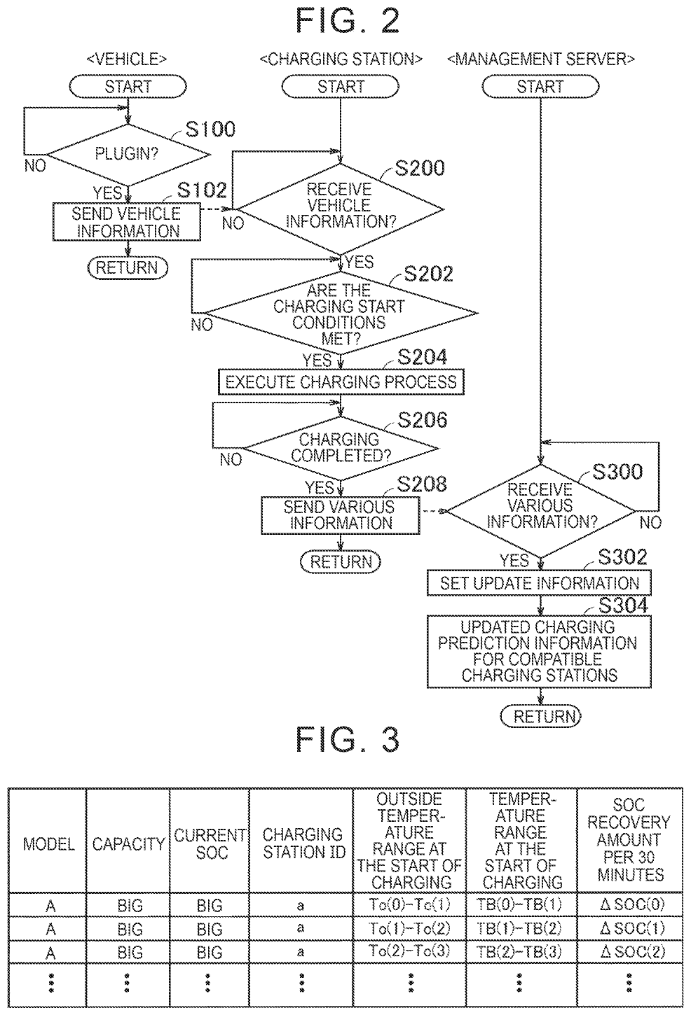

Hereinafter, an example of processing executed between vehicle 2, management server 100, and charging station 300 will be described with reference to FIG. 2. FIG. 2 is a flowchart showing an example of processing executed between the vehicle 2, the management server 100, and the charging station 300. The processing shown in this flowchart is repeatedly executed in each of vehicle 2, management server 100, and charging station 300 at predetermined control cycles. Processing executed in the vehicle 2 (specifically, the ECU 10) will be described below.

At step (hereinafter, step is described as S) 100, the vehicle 2 determines whether or not it has been plugged in. The ECU 10 of the vehicle 2 determines that the plug is plugged in when it detects that the plug is attached to the inlet by a signal from a sensor (not shown) or a predetermined circuit. A sensor or a predetermined circuit (not shown), for example, outputs an ON signal when the plug is attached to the inlet, and stops outputting the ON signal (or outputs an OFF signal) when the plug is removed from the inlet. It may be a contact sensor or a switch circuit. If it is determined that the plug-in has been made (YES at S100), the process proceeds to S102.

In S102, vehicle 2 transmits vehicle information to charging station 300. The vehicle 2 may transmit vehicle information to the charging station 300 by power line communication or the like via the plugged-in plug and cable. Alternatively, vehicle 2 may transmit vehicle information to charging station 300 by wireless communication when wireless communication is possible with charging station 300. Vehicle information includes, for example, information about the model of the vehicle 2, information about the capacity of power storage device 20 mounted on vehicle 2, and information about the current SOC of power storage device 20. The process is then terminated. If it is determined that the plug-in has not been made (NO in S100), the process returns to S100.

Next, processing executed in charging station 300 (specifically, the control device of charging station 300) will be described.

At S200, charging station 300 determines whether to receive vehicle information. Since the vehicle information is as described above, detailed description thereof will not be repeated. If it is determined that vehicle information has been received (YES at S200), the process proceeds to S202. If it is determined that vehicle information has not been received (NO in S200), the process returns to S200.

At S202, charging station 300 determines whether charging start conditions are satisfied. The charging start condition includes, for example, a plug-in condition. In this case, charging station 300 determines that the charging start condition is satisfied, for example, because it is determined that plug-in has been performed in the process of S200.

Alternatively, the charging start condition may include a condition that an operation for starting charging has been accepted. In this case, charging station 300 may determine that the charging start condition is met when an operation for starting charging (for example, an operation on charging station 300 or an operation on vehicle 2) is received. If it is determined that the charging start condition is satisfied (YES in S202), the process proceeds to S204. If it is determined that the charging start condition is not satisfied (NO in S202), the process returns to S202.

At S204, charging station 300 executes a charging process. The charging process includes a process of charging the power storage device 20 mounted on vehicle 2. Charging station 300 controls, for example, the voltage applied to power storage device 20 and the current flowing through the power storage device 20 so that power capable of charging the power storage device 20 is supplied. For example, charging station 300 controls the charging power so that the temperature state of power storage device 20 does not exceed a predetermined range during charging, and reduces the charging power when the temperature exceeds the predetermined range. The charging station 300 executes the charging process until a predetermined period of time has elapsed since charging was started, and ends the charging process when the predetermined period of time has elapsed. The predetermined period may be, for example, a period of about 30 minutes when quick charging is performed at charging station 300, or about 1 hour or 2 hours when normal charging is performed, or a period set by the user. After that, the process moves to S206.

At S206, charging station 300 determines whether charging has been completed. Charging station 300 determines that charging is completed, for example, when a predetermined period of time has elapsed. If it is determined that charging has been completed (YES at S206), the process proceeds to S208. If it is determined that charging has not been completed (NO in S206), the process returns to S206.

In S208, charging station 300 transmits various information to management server 100. The various types of information include vehicle information received from the vehicle 2, the amount of charge charged by the charging process performed until a predetermined period of time has elapsed, information on the outside temperature at the start of charging, and identification information specifying the charging station 300 (hereinafter referred to as, charging station ID). The vehicle information includes temperature information of power storage device 20 at the start of charging. Charging station 300 may acquire the outside temperature for charging, for example, using an outside temperature sensor (not shown). The process is then terminated.

Next, processing executed in the management server 100 (specifically, the control device 11) will be described.

At S300, management server 100 determines whether to receive various information from charging station 300. When management server 100 determines that various types of information have been received from charging station 300 (YES in S300), the process proceeds to S302.

In S302, management server 100 sets update information for charging prediction information. The management server 100 receives the received charging station ID, the model, the capacity of the power storage device 20, the current SOC of the power storage device 20, the amount of charge in a predetermined period, the temperature at the start of charging, and the start of charging. Information associated with the temperature of the power storage device 20 at that time is set as the update information. After that, the process moves to S304.

At S304, management server 100 updates the charging prediction information of the corresponding charging station using the update information. FIG. 3 is a diagram showing an example of charging prediction information in tabular form. As shown in FIG. 3, the charging prediction information includes, for example, a first item that identifies the model, a second item that identifies the capacity of power storage device 20 in three stages, and a current SOC of power storage device 20 in three stages. A third item for identifying a charging station, a fourth item for identifying a charging station, a fifth item for identifying the outside temperature at the start of charging in a plurality of temperature ranges, a sixth item of identifying the temperature of the power storage device 20 at the start of charging in a plurality of temperature ranges, and a seventh item that specifies the chargeable amount (SOC recovery amount) in a predetermined period.

Note that FIG. 3 shows charging prediction information for a charging station 300 whose model is “A”, whose capacity and current SOC are both in the “large” category, and whose charging station ID is “b”. An example is shown. In FIG. 3, when the outside air temperature range at the start of charging is To(0)-To(1) and the temperature range of power storage device 20 is TB(0)-TB(1), chargeable amount is shown to be ΔSOC(0). Further, FIG. 3 shows that, when the outside air temperature range at the start of charging is To(1)-To(2) and the temperature range of the power storage device 20 is TB(1)-TB(2), chargeable amount per predetermined period is ΔSOC(1). Further, FIG. 3 shows that, when the outside air temperature range at the start of charging is To(2)-To(3) and the temperature range of the power storage device 20 is TB(2)-TB(3), chargeable amount per predetermined period is ΔSOC(2).

Management server 100 uses the update information to identify the seventh item corresponding to the first to sixth items, and updates the chargeable amount included in the identified seventh item. For example, the management server 100 may be updated by rewriting to the chargeable amount included in the update information. Alternatively, the update may be performed by rewriting the average value of the chargeable amount included in the update information and the chargeable amount for a predetermined period (or a predetermined number) immediately before. Alternatively, statistical processing is performed using the chargeable amount included in the update information and the chargeable amount in the entire period up to the immediately preceding period, and, for example, the chargeable amount that is frequently calculated is obtained. It may be updated by rewriting to. The process is then terminated.

The chargeable amount for a predetermined period for each model stored in the management server 100 is displayed together with the positions of the charging stations around the object point requested in response to the search request from the terminal 200.

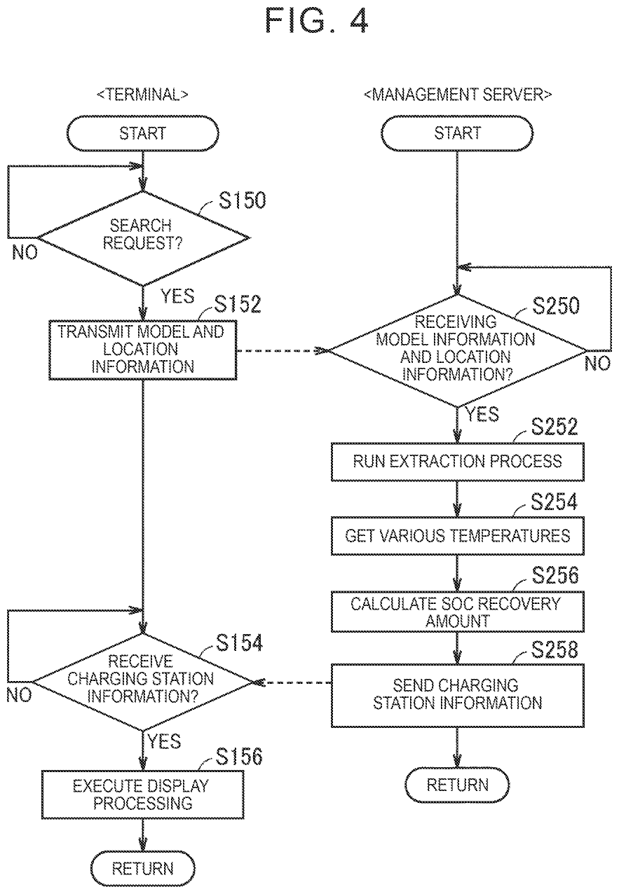

An example of processing executed between the management server 100 and the terminal 200 will be described below with reference to FIG. 4. FIG. 4 is a flowchart showing an example of processing executed between the management server 100 and the terminal 200. As shown in FIG. The processing shown in this flowchart is repeatedly executed in each of the management server 100 and the terminal 200 at each predetermined control cycle. Processing executed in the terminal 200 (specifically, the control device 200a) will be described below.

At S150, terminal 200 determines whether there is a search request. For example, terminal 200 determines that there is a search request when an operation for searching for charging stations around terminal 200 is received while an application for searching for charging stations is running. If it is determined that there is a search request (YES at S150), the process proceeds to S152.

At S152, terminal 200 transmits the model information and the location information to management server 100. The terminal 200 acquires, for example, model information registered in advance by a user's operation or model information received through communication with the user's vehicle 2. The model information includes information about the model and information about the capacity of the installed power storage device 20. Also, the terminal 200 acquires position information obtained by the position detection device of the terminal 200 or position information received through communication with the vehicle 2, for example. After that, the process moves to S154.

At S154, terminal 200 determines whether to receive charging station information from management server 100. The charging station information includes location information about a plurality of charging stations 300 within a predetermined distance from the location of the terminal 200, and information about the SOC recovery amount (chargeable amount) in each charging station 300 in a predetermined period. If it is determined that charging station information has been received (YES at S154), the process proceeds to S156. If it is determined that the charging station information has not been received (NO in S154), the process returns to S154.

At S156, terminal 200 executes a display process. Terminal 200 displays, on a display device such as a touch panel display, an image indicating the location of charging station 300 together with surrounding map information, and information such as numbers (percentage, power consumption, etc.) and images indicating the SOC recovery amount. Execute display processing to Processing is then terminated. Terminal 200 may display, for example, the SOC before charging and the SOC after charging, or may display the state of charge before charging and the state of charge after charging using an image such as a bar graph.

Next, processing executed in the management server 100 (specifically, the control device 11) will be described.

At S250, management server 100 determines whether to receive model information and location information. Since the model information and position information are as described above, detailed description thereof will not be repeated. If it is determined that model information and location information have been received (YES at S250), the process proceeds to S252.

At S252, management server 100 executes an extraction process. Specifically, management server 100 executes a process of extracting charging station 300 within a predetermined distance from the object point based on the position information received from terminal 200. Management server 100 extracts, for example, charging station IDs within a predetermined distance from the object point from the position information associated with each charging station ID stored in storage device 15. After that, the process moves to S254.

At S254, management server 100 acquires various temperatures. Specifically, management server 100 may acquire the extracted outside temperature of each charging station 300 from another server, or may acquire the outside temperature from each charging station 300. Furthermore, the management server 100 may acquire the temperature of the power storage device 20 of the vehicle 2 to be charged from the terminal 200 or the vehicle 2. After that, the process moves to S256.

At S256, management server 100 calculates the recovery amount of the SOC at each of the extracted charging stations 300. The management server 100 calculates the SOC recovery amount of each charging station using the acquired model information and various temperatures, the extracted charging station ID, and the acquired charging prediction information shown in FIG. 3. After that, the process moves to S258.

In S258, management server 100 transmits to terminal 200 the extracted charging station information including the location information of each charging station 300 and the SOC recovery amount. Processing is then terminated.

An example of the operation of the vehicle 2, the management server 100, the terminal 200, and the charging station 300 based on the structure and flowchart as described above will be described.

### SOC Recovery Amount Update

For example, assume that the vehicle 2 is parked in a parking space corresponding to one of the charging stations 300 among the plurality of charging stations. When the user connects the plug of charging station 300 to the inlet of vehicle 2, it is determined that the plug has been made (YES at S100), and vehicle information is transmitted from vehicle 2 to charging station 300 (S102).

When charging station 300 receives vehicle information from vehicle 2 (YES in S200) and accepts an operation to start charging (YES in S202), charging processing is executed. (S204). When it is determined that charging has been completed after a predetermined period of time has elapsed (YES in S206), various types of information are transmitted from charging station 300 to management server 100 (S208).

In management server 100, when various information is received (YES at S300), update information is calculated. The charging prediction information of the corresponding charging station 300 is updated using the calculated update information. At this time, the model, capacity, charging station ID, outside temperature range, and SOC recovery amount corresponding to the temperature range of power storage device 20 included in the charging prediction information are updated using the update information. Each time charging is performed at each of the plurality of charging stations 300 managed by management server 100, various types of information are transmitted to management server 100, and the SOC recovery amount is updated.

### Search for Charging Stations

For example, assume that the user operates the terminal 200 to search for nearby charging stations. When terminal 200 receives a user's operation and determines that there is a search request (YES in S150), the model information and the location information of the object point (for example, the location information of the vehicle owned by the user) are sent to the management server. 100 (S152).

When management server 100 receives model information and location information (YES at S250), an extraction process is executed (S252) to extract charging stations 300 around the object point. After that, various temperatures are acquired (S254), and the SOC recovery amount of each charging station 300 extracted using the charging prediction information is calculated (S256), and the charging station information including the calculated SOC recovery amount is transmitted to the terminal 200 (S258).

When charging station information is received at terminal 200 (YES at S154), display processing is executed (S156). Therefore, an image indicating the position of charging station 300 within a predetermined distance from the object point and character information indicating the SOC recovery amount of displayed charging station 300 are displayed on the map. Therefore, the user can visually recognize the positions of the surrounding charging stations 300 and the SOC recovery amount at each charging station 300 through the display device of the terminal 200.

As described above, according to the information management system 1 according to the present embodiment, the terminal 200 displays the chargeable amount (SOC recovery amount) for a predetermined period at the charging station 300 around the object point, so the user can select a charging station capable of charging as intended by the user. Therefore, it is possible to provide an information management system capable of providing information on charging stations where charging intended by the user is possible.

Furthermore, when charging is performed at each charging station 300, the charging history is used to update the chargeable amount for each model, so that it is possible to obtain highly accurate information on the charging station where charging intended by the user is possible.

Hereinafter, modifications will be described.

In the above-described embodiment, the terminal 200 is used to search for charging stations 300 around the object point. However, the charging station 300 around the vehicle 2 may be searched using a terminal mounted on the vehicle 2 instead of the terminal 200, for example. A terminal of the vehicle 2 is configured by an ECU 10, a communication device 30, and a navigation device 60, for example.

In the above-described embodiment, the update information is set using various information from the charging station 300, but the various information may include, for example, the upper limit of the charging power of the charging station 300.

Furthermore, in the above-described embodiment, the charging prediction information of the charging station 300 is set for each location, but common charging prediction information may be set for the charging stations 300 of the same model.

Furthermore, in the above-described embodiment, the case where various information is transmitted from charging station 300 to management server 100 has been described as an example. However, upon sending a predetermined piece of information from the charging station 300 to the vehicle 2, various kinds of information may be sent from the vehicle 2 to the management server 100.

Furthermore, in the above-described embodiment, the location information of charging stations 300 around the object point and the SOC recovery amount are displayed. However, an increase in the cruising range may be displayed instead of or in addition to the SOC recovery amount.

Furthermore, in the above-described embodiment, it is assumed that the location of vehicle 2 and the location of terminal 200 are used as object points to search charging stations 300 in the vicinity. However, a point shorter than the travelable distance may be set as the object point, when a destination of the vehicle 2 is set in the navigation device 60, for example. In this way, the charging stations 300 in the vicinity of the object point can be displayed as waypoints, so that an appropriate charging station can be selected as the waypoint when charging is required before reaching the destination.

In addition, the above-mentioned modifications may be carried out by appropriately combining all or a part thereof.

The embodiment disclosed herein should be considered to be exemplary and not restrictive in all respects. The scope of the present disclosure is shown by the scope of claims rather than the description above, and is intended to include all modifications within the meaning and the scope equivalent to the scope of claims.

What is claimed is:

1. An information management system, comprising:
a plurality of charging facilities, each of the charging facilities being configured to externally charge a power storage device installed in a vehicle;
a server that manages a chargeable amount that is chargeable to the power storage device in a predetermined period, in each of the charging facilities; and
a terminal that includes a display device and that is configured to make a search request to the server for the charging facilities, wherein upon receiving the search request, the server causes the display device of the terminal to display information regarding the charging facility in a vicinity of an object point, and the chargeable amount at the charging facility.

2. The information management system according to claim 1, wherein:
when the charging of the power storage device is completed, the charging facility transmits charging history, along with model information of the vehicle and information regarding the power storage device, to the server; and
the server updates the chargeable amount for each model, using the charging history.

3. The information management system according to claim 2, wherein the charging history includes an amount of charge in the predetermined period, history of outside temperature during charging, and history of temperature of the power storage device.

4. The information management system according to claim 1, wherein the terminal sets a current position of the vehicle as the object point.

5. The information management system according to claim 1, wherein the terminal sets a point that is partway between a current position of the vehicle and a destination of the vehicle, and also that is a point at a distance shorter than a travelable distance of the vehicle, as the object point, and displays the charging facility acquired by the search request on the display device as an option for a waypoint.
